(19) United States
(12) Patent Application Publication
(10) Pub. No.: US 2022/0127513 A1
(43) Pub. Date: Apr. 28, 2022

(54) DOWNHOLE TREATMENT COMPOSITIONS COMPRISING LOW TEMPERATURE DEGRADABLE DIVERTING AGENTS AND METHODS OF USE IN DOWNHOLE FORMATIONS

(71) Applicant: Eastman Chemical Company, Kingsport, TN (US)

(72) Inventors: Devin G. Barrett, Jonesborough, TN (US); Nick Allen Collins, Fall Branch, TN (US); Koushik Ghosh, Albuquerque, NM (US)

(73) Assignee: Eastman Chemical Company, Kingsport, TN (US)

(21) Appl. No.: 17/310,719

(22) PCT Filed: Feb. 18, 2020
(86) PCT No.: PCT/US2020/018611

§ 371 Date: Aug. 19, 2021

Related U.S. Application Data
(60) Provisional application No. 62/807,962, filed on Feb. 20, 2019.

(51) Int. Cl. C09K 8/514; C09K 8/508; C09K 8/80; E21B 33/138; E21B 43/267

(52) U.S. Cl. CPC C09K 8/514; C09K 8/5086; E21B 43/267; C09K 8/80; E21B 33/138; C09K 8/5083

(57) ABSTRACT

Degradable particulate materials are provided that may be utilized in various wellbore treatment fluids, such as hydraulic fracturing fluids. In particular, the degradable particulate materials can be formed from a cellulosic polymer, a polyester polymer, a polyvinyl alcohol, or a guar gum ester that are capable of effectively degrading at specific rates when exposed to the aqueous environments in low temperature wellbores (50° C. to 100° C.).

### FIELD OF THE INVENTION

The present invention relates to downhole treatment compositions comprising degradable diverting agents and methods of using the downhole treatment compositions in downhole or subterranean formations.

### BACKGROUND OF THE INVENTION

Hydrocarbon-producing wells are often stimulated by hydraulic fracturing operations, wherein a wellbore treatment fluid may be introduced into a portion of a downhole formation penetrated by a well bore at a hydraulic pressure sufficient to create or enhance at least one fracture therein. Often, particulate solids, such as graded sand, will be suspended in a portion of the wellbore treatment fluid so that the proppant particles may be placed in the resultant fractures to maintain the integrity of the fractures (after the hydraulic pressure is released), thereby forming conductive channels within the formation through which hydrocarbons can flow. Once at least one fracture has been created and at least a portion of the proppant is substantially in place within the fracture, the viscosity of the wellbore treatment fluid may be reduced to facilitate removal of the wellbore treatment fluid from the formation.

In certain hydrocarbon-producing formations, much of the production may be derived from natural fractures. These natural fractures may exist in the reservoir prior to a fracturing operation, and, when contacted by an induced fracture (e.g., a fracture formed or enhanced during a fracturing treatment), may provide flow channels having a relatively high conductivity that may improve hydrocarbon production from the reservoir. However, fracturing treatments often may be problematic in naturally-fractured reservoirs, or in any other reservoirs where an existing fracture could intersect a created or enhanced fracture. In such situations, the intersection of the fractures could impart a highly tortuous shape to the created or enhanced fracture, which could result in, e.g., premature screenout. Additionally, the initiation of a fracturing treatment on a well bore intersected with multiple natural fractures may cause multiple fractures to be initiated, each having a relatively short length, which also could cause undesirable premature screenouts.

In an attempt to address these problems, wellbore treatment fluids are often formulated to include diverting agents that may, inter alia, form a temporary plug in the perforations or natural fractures that tend to accept the greatest fluid flow, thereby diverting the remaining wellbore treatment fluid to the generated fracture. However, conventional diverting agents may be difficult to remove completely from the downhole formation, which may cause a residue to remain in the well bore area following the fracturing operation, which may permanently reduce the permeability of the formation. In some cases, difficulty in removing conventional diverting agents from the formation may permanently reduce the permeability of the formation by between 5% to 40%, and may even cause a 100% permanent reduction in permeability in some instances. This situation can be remedied by using degradable diverting agents that dissolve, disperse, or breakdown in the downhole wells. Therefore, there is a need for new degradable diverting agents.

### SUMMARY OF THE INVENTION

The present application discloses a wellbore treatment composition comprising:

(1) a first solid particulate, comprising a first degradable material; and

(2) a base fluid,
wherein the first solid particulate has a first graded particle size in the range of from about 60 to about 100 U.S. Standard Mesh,
wherein the first solid particulate exhibits a percent weight loss of not more than forty percent (40%) after 4 hours at 100° C. in deionized water,
wherein the first degradable material comprises is:
   (I) a cellulosic polymer comprising
      (a) a plurality of —CH₂COOR¹ substituents, wherein the degree of substitution of the —CH₂COOR¹ substituents is in the range of from about 0.4 to about 1.5; and a plurality of (C₁₋₆)alkyl-CO— substituents, wherein the degree of substitution of the (C₁₋₆)alkyl-CO— substituents is in the range of from 0 to about 2.5, wherein R¹ is hydrogen or (C₁₋₆)alkyl;
      (b) a plurality of (C₂₋₃)alkyl-OR² substituents, wherein the degree of substitution of the (C₂₋₃)alkyl-OR² substituents is in the range of from about 0.4 to about 2.9; and a plurality of (C₁₋₆)alkyl-CO— substituents, wherein the degree of substitution of the (C₁₋₆)alkyl-CO— substituents is in the range of from 0 to about 2.5; wherein R² is hydrogen, or (C₁₋₆)alkyl-CO—;
      (c) a plurality of COOH substituents, wherein the degree of substitution of the COOH substituents is in the range of from 0.1 to 0.5, and a plurality of (C₁₋₆)alkyl-CO— substituents, wherein the degree of substitution of the (C₁₋₆)alkyl-CO— substituents is in the range of from 0 to about 2.5; or
      (d) a plurality of

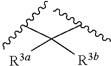

substituents which are acetals or ketals, wherein the degree of substitution of the

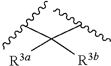

substituents is from about 0.2 to about 1, wherein each R^{3a} and R^{3b} are independently hydrogen, (C₁₋₆)alkyl, (C₃₋₆)cycloalkyl, or phenyl, and R^{3a} and R^{3b} are not both hydrogen;
(II) a polyester polymer comprising 5 mole % to 30 mole % of isophthalic-S(O)₂—OH residues based on the total diacid component of the polyester polymer;
(III) a polyvinyl alcohol comprising a plurality of R⁵—CO— substituents, wherein each R⁵ is independently hydrogen or (C₁₋₆)alkyl; or
(IV) a guar gum ester, comprising a plurality of (C₁₋₆)alkyl-CO— substituents, wherein the degree of substitution of the (C₁₋₆)alkyl-CO— is in the range of from 0.4 to 2.7.
   The present application also discloses methods of using the downhole well treatment compositions.

The features and advantages will be readily apparent to those skilled in the art upon a reading of the description.

### DETAILED DESCRIPTION

As used herein, the terms “a,” “an,” and “the” mean one or more.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons”, is intended to specifically include and disclose C₁ and C₅ hydrocarbons as well as C₂, C₃, and C₄ hydrocarbons.

Degradable as used herein means that a material is capable of dissolving, dispersing, breaking down, or chemically deteriorating. The degradation can occur by bulk erosion and surface erosion, and any stage of degradation in between these two. Degradation can occur by chemical reactions in the downhole well with water or other chemicals. The degradation can also occur by intramolecular chemical reactions. The degradable material disclosed in this application degrade by first dissolving or dispersing in the downhole well. Once dissolved or dispersed, further chemical reactions may occur in the downhole formation to break down the degradable material into smaller molecules.

“Diverter” or “diverting agent” means anything used in a well to cause something to turn or flow in a different direction, e.g., a diversion material or mechanical device; a Solid or fluid that may plug or fill, either partially or fully, a portion of a downhole formation.

“Fracture” means a crack or surface of breakage within rock.

“Proppant” are typically granular materials such as sand, ceramic beads, and other materials. Proppants are typically used to hold fractures open after pressures are reduced.

As used herein the term “chosen from” used with the terms “and’ or “or when used in a list of two or more items, means that any one of the listed items can be employed by itself in the case of “chosen from” in conjunction with “and,” or means that any one of the listed items can be employed by itself or in any combination in the case of “chosen from” in conjunction with “or”, or any combination of two or more of the listed items can be employed. For example, if a composition is described as chosen from A, B, and C, the composition can contain A alone; B alone; or C alone. For example, if a composition is described as chosen from A, B, or C, the composition can contain A alone; B alone; C alone; A and B in combination; A and C in combination; B and C in combination; or A, B, and C in combination.

The cellulose ester utilized in this invention can be any that is known in the art. The cellulose esters of the present invention generally comprise repeating units of the structure:

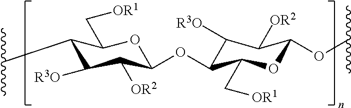

wherein R¹, R², and R³ are selected independently from the group consisting of hydrogen or straight chain alkanoyl having from 2 to 10 carbon atoms. For cellulose esters, the substitution level is usually express in terms of degree of substitution (DS), which is the average number of substituents per anhydroglucose unit (AGU). Generally, conventional cellulose contains three hydroxyl groups in each AGU unit that can be substituted; therefore DS can have a value between zero and three. However, low molecular weight cellulose mixed esters can have a total degree of substitution ranged from about 3.08 to about 3.5. Native cellulose is a large polysaccharide with a degree of polymerization from 700-2,000, and thus the assumption that the maximum DS is 3.0 is approximately correct. However, as the degree of polymerization is lowered, as in low molecular weight cellulose mixed esters, the end groups of the polysaccharide backbone become relatively more significant, thereby resulting in a DS ranging from about 3.08 to about 3.5. Low molecular weight cellulose mixed esters are discussed in more detail subsequently in this disclosure. Because DS is a statistical mean value, a value of 1 does not assure that every AGU has a single substituent. In some cases, there can be unsubstituted anhydroglucose units, some with two and some with three substituents, and more often than not the value will be a noninteger. Total DS is defined as the average number of all of substituents per anhydroglucose unit. The degree of substitution per AGU can also refer to a particular substituent, such as, for example, hydroxyl, acetyl, butyryl, or propionyl. The DS_{OH} means the average hydroxyl groups, that are not substituted, on the AGU; which can be as high as 3. If the average number of hydroxyl groups per AGU is 2, then the DS_{OH} is 2.

Cellulose derivatives can be oxidized at the C6 position to a carboxy group:

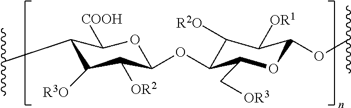

The DS per anhydroglucose unit can be zero or one (DS 0 or 1) for the carboxy group. However, the average degree of substitution of the carboxy group for the cellulose derivative can be from zero to one (DS 0-1).

In the case of cyclic acetals or ketals, the anhydroglucose unit can also form cyclic acetals or ketals, one per anhyroglucose unit. Therefore, the DS per anhydroglucose unit can be zero or one. However, the average degree of substitution for cellulose which is a polymer of anhyroglucose units with cyclic acetals or ketals can be a number from zero to one (DS 0-1).

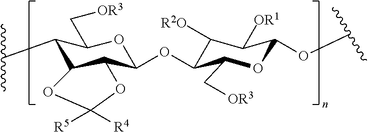

Polyesters comprising isophthalic-S(O)₂—OH residues are known as sulfopolyesters. The -isophthalic-S(O)₂—OH residues impart water dispersibility to sulfopolyester polymers based on the mole percentage of the isophthalic-S(O)₂—OH residues in the polymer. The remaining residues of the sulfopolyesters are derived from at least one dicarboxylic acid and at least one diol. The total of the at least one dicarboxylic acid and the sulfopolyesters is 100 mole % and the total of the at least one diol is 100 mole %. U.S. Pat. Nos. 5,011,877 5,037,947, 5,011,877 and 5,037,947 provide examples of sulfopolyesters.

Examples of dicarboxylic acids that can be used include generally aliphatic, alicyclic, aromatic dicarboxylic acids, and combinations thereof. Suitable dicarboxylic acids include malonic, dimethylmalonic, succinic, dodecanedioic, glutaric, adipic, trimethyladipic, pimelic, 2,2-dimethylglutaric, azelaic, sebacic, fumaric, suberic, maleic, itaconic, 1,3-cyclopentane dicarboxylic, 1,2-cyclohexanedicarboxylic, 1,3-cyclohexanedicarboxylic, 1,4-cyclohexanedicarboxylic, phthalic, terephthalic, isophthalic, 2,5-norbornanedicarboxylic, diphenic, 4,4′-oxydibenzoic, diglycolic, thiodipropionic, 4,4′-sulfonyldibenzoic, and naphthalenedicarboxylic acids. The anhydride, acid chloride, and ester derivatives of the above acids may also be used.

Examples of diols include generally aliphatic diols, cycloaliphatic diols, aromatic diols and combinations thereof. The aliphatic diols preferably have 2 to 20 carbon atoms, and the cycloaliphatic diols preferably have 6 to 20 carbon atoms. The diol component may also include mixtures of diols. Included within the class of aliphatic diols are aliphatic diols having ether linkages such as polydiols having 4 to 800 carbon atoms. Suitable diols include: ethylene glycol, diethylene glycol, triethylene glycol, 1,2-propanediol, 1,3-propanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 1,4-butanediol, 1,5-pentanediol, 1,6-hexanediol, 2,2,4-trimethyl-1,6-hexanediol, thioethanol, 1,2-cyclohexanedimethanol, 1,3-cyclohexanedimethanol, and 1,4-cyclohexanedimethanol. Preferably, the diol(s) are ethylene glycol, combinations of ethylene glycol with diethylene glycol, combinations of diethylene glycol with 1,4-cyclohexanedimethanol, combinations of ethylene glycol with 1,4-cyclohexanedimethanol, and combinations of ethylene glycol or diethylene glycol with a variety of suitable co-diols.

The downhole treatment composition, disclosed herein, is suitable for use in, inter alia, hydraulic fracturing and frac-packing applications. The downhole treatment composition may be flowed through a downhole formation as part of a downhole operation (e.g., hydraulic fracturing), and the first solid particulate described herein may bridge or obstruct pore throats in smaller fractures that may be perpendicular to the one or more dominant factures being formed in the formation. Among other things, this may provide additional flow capacity that may facilitate extending one or more dominant fractures in the formation. The first solid particulate described herein may facilitate increased hydrocarbon production from the formation after the conclusion of the treatment operation, inter alia, because the dissolution or dispersion of the first solid particulate may enhance flow of hydrocarbons from the formation into the one or more dominant fractures, from which point the hydrocarbons may flow to the well bore and then to the surface, where they may be produced.

The rate of degradation of degradable materials depends on a number of physical and chemical factors of both the degradable material and the environment around the degradable material. Physical factors of the degradable material that may affect its degradation rate include, for example, shape, dimensions, roughness, and porosity. Physical factors of the environment that may affect degradation rate include, for example, temperature, pressure, and agitation. The relative chemical make-up of the degradable material and the environment within which it is placed can greatly influence the rate of degradation of the material.

One of the degradable materials disclosed herein, is hydrogen carboxymethyl cellulose. Carboxymethyl cellulose (“CMC”) as discussed in the prior art typically refers to a metal salt (e.g., sodium) of hydrogen carboxymethyl cellulose. Moreover, the material is generally only commercially available as a salt. The salt of CMC is very degradable, more specifically dissolvable/dispersible, in water. As will be discussed further in this application, hydrogen carboxymethyl cellulose exhibits a delayed degradability that is amenable to low temperature (50-100° C.) diverter applications.

In one embodiment, the first solid particulate exhibits a percent weight loss of not more than two percent (2%) after 4 hours at a temperature in the range of from 50° C. to 100° C. in deionized water. In one class of this embodiment, the first solid particulate exhibits a percent weight loss of not less than sixty-five percent (65%) after 189 hours at a temperature in the range of from 50° C. to 100° C. in deionized water. In one class of this embodiment, the first solid particulate exhibits a percent weight loss of not less than seventy-five percent (75%) after 189 hours at a temperature in the range of from 50° C. to 100° C. in deionized water.

In one embodiment, the first solid particulate exhibits a percent weight loss of not more than five percent (5%) after 4 hours at a temperature in the range of from 50° C. to 100° C. in deionized water. In one class of this embodiment, the first solid particulate exhibits a percent weight loss of not less than sixty-five percent (65%) after 189 hours at a temperature in the range of from 50° C. to 100° C. in deionized water. In one class of this embodiment, the first solid particulate exhibits a percent weight loss of not less than seventy-five percent (75%) after 189 hours at a temperature in the range of from 50° C. to 100° C. in deionized water.

In one embodiment, the first solid particulate exhibits a percent weight loss of not more than eight percent (8%) after 4 hours at a temperature in the range of from 50° C. to 100° C. in deionized water. In one class of this embodiment, the first solid particulate exhibits a percent weight loss of not less than sixty-five percent (65%) after 189 hours at a temperature in the range of from 50° C. to 100° C. in deionized water. In one class of this embodiment, the first solid particulate exhibits a percent weight loss of not less than seventy-five percent (75%) after 189 hours at a temperature in the range of from 50° C. to 100° C. in deionized water.

In one embodiment, the first solid particulate exhibits a percent weight loss of not more than ten percent (10%) after 4 hours at a temperature in the range of from 50° C. to 100° C. in deionized water. In one class of this embodiment, the first solid particulate exhibits a percent weight loss of not less than sixty-five percent (65%) after 189 hours at a temperature in the range of from 50° C. to 100° C. in deionized water In one class of this embodiment, the first solid particulate exhibits a percent weight loss of not less than seventy-five percent (75%) after 189 hours at a temperature in the range of from 50° C. to 100° C. in deionized water.

In one embodiment, the first solid particulate exhibits a percent weight loss of not more than fifteen percent (15%) after 4 hours at a temperature in the range of from 50° C. to 100° C. in deionized water. In one class of this embodiment, the first solid particulate exhibits a percent weight loss of not less than sixty-five percent (65%) after 189 hours at a temperature in the range of from 50° C. to 100° C. in deionized water. In one class of this embodiment, the first solid particulate exhibits a percent weight loss of not less than seventy-five percent (75%) after 189 hours at a temperature in the range of from 50° C. to 100° C. in deionized water.

In one embodiment, the first solid particulate exhibits a percent weight loss of not more than twenty percent (20%) after 4 hours at a temperature in the range of from 50° C. to 100° C. in deionized water. In one class of this embodiment, the first solid particulate exhibits a percent weight loss of not less than sixty-five percent (65%) after 189 hours at a temperature in the range of from 50° C. to 100° C. in deionized water. In one class of this embodiment, the first solid particulate exhibits a percent weight loss of not less than seventy-five percent (75%) after 189 hours at a temperature in the range of from 50° C. to 100° C. in deionized water.

In one embodiment, the first solid particulate exhibits a percent weight loss of not more than twenty-five percent (25%) after 4 hours at a temperature in the range of from 50° C. to 100° C. in deionized water. In one class of this embodiment, the first solid particulate exhibits a percent weight loss of not less than sixty-five percent (65%) after 189 hours at a temperature in the range of from 50° C. to 100° C. in deionized water. In one class of this embodiment, the first solid particulate exhibits a percent weight loss of not less than seventy-five percent (75%) after 189 hours at a temperature in the range of from 50° C. to 100° C. in deionized water.

In one embodiment, the first solid particulate exhibits a percent weight loss of not more than thirty percent (30%) after 4 hours at a temperature in the range of from 50° C. to 100° C. in deionized water. In one class of this embodiment, the first solid particulate exhibits a percent weight loss of not less than sixty-five percent (65%) after 189 hours at a temperature in the range of from 50° C. to 100° C. in deionized water. In one class of this embodiment, the first solid particulate exhibits a percent weight loss of not less than seventy-five percent (75%) after 189 hours at a temperature in the range of from 50° C. to 100° C. in deionized water.

In one embodiment, the first solid particulate exhibits a percent weight loss of not more than thirty-five percent (35%) after 4 hours at a temperature in the range of from 50° C. to 100° C. in deionized water. In one class of this embodiment, the first solid particulate exhibits a percent weight loss of not less than sixty-five percent (65%) after 189 hours at a temperature in the range of from 50° C. to 100° C. in deionized water. In one class of this embodiment, the first solid particulate exhibits a percent weight loss of not less than seventy-five percent (75%) after 189 hours at a temperature in the range of from 50° C. to 100° C. in deionized water.

In one embodiment, the first solid particulate exhibits a percent weight loss of not more than two percent (2%) after 8 hours at a temperature in the range of from 50° C. to 100° C. in deionized water. In one embodiment, the first solid particulate exhibits a percent weight loss of not more than five percent (5%) after 8 hours at a temperature in the range of from 50° C. to 100° C. in deionized water. In one embodiment, the first solid particulate exhibits a percent weight loss of not more than eight percent (8%) after 8 hours at 100° C. in deionized water. In one embodiment, the first solid particulate exhibits a percent weight loss of not more than ten percent (10%) after 8 hours at 100° C. in deionized water. In one embodiment, the first solid particulate exhibits a percent weight loss of not more than fifteen percent (15%) after 8 hours at 100° C. in deionized water. In one embodiment, the first solid particulate exhibits a percent weight loss of not more than twenty percent (20%) after 8 hours at 100° C. in deionized water. In one embodiment, the first solid particulate exhibits a percent weight loss of not more than twenty-five percent (25%) after 8 hours at 100° C. in deionized water. In one embodiment, the first solid particulate exhibits a percent weight loss of not more than thirty percent (30%) after 8 hours at 100° C. in deionized water. In one embodiment, the first solid particulate exhibits a percent weight loss of not more than thirty-five percent (35%) after 8 hours at 100° C. in deionized water.

In one embodiment, the first solid particulate exhibits a percent weight loss of at least fifty percent (50%) after 48 hours at 100° C. in deionized water. In one embodiment, the first solid particulate exhibits a percent weight loss of at least sixty-five percent (65%) after 48 hours at 100° C. in deionized water. In one embodiment, the first solid particulate exhibits a percent weight loss of at least seventy percent (70%) after 48 hours at 100° C. in deionized water. In one embodiment, the first solid particulate exhibits a percent weight loss of at least seventy-five percent (75%) after 48 hours at 100° C. in deionized water. In one embodiment, the first solid particulate exhibits a percent weight loss of at least eighty percent (80%) after 48 hours at 100° C. in deionized water. In one embodiment, the first solid particulate exhibits a percent weight loss of at least eighty-five percent (85%) after 48 hours at 100° C. in deionized water. In one embodiment, the first solid particulate exhibits a percent weight loss of at least ninety percent (90%) after 48 hours at 100° C. in deionized water. In one embodiment, the first solid particulate exhibits a percent weight loss of at least ninety-five percent (95%) after 48 hours at 100° C. in deionized water.

The specific features of the solid particulates disclosed in the present application may be modified so as to prevent loss of fluid to the formation. The solid particulates may have any shape, including, but not limited to, particles having the physical shape of platelets, shavings, flakes, ribbons, rods, strips, spheroids, toroids, pellets, tablets, or any other physical shape. One of ordinary skill in the art, with the benefit of this disclosure, will recognize the specific degradable material that may be used in the degradable diverting agents, and the preferred size and shape for a given application.

A variety of base fluids may be included in the wellbore treatment fluids used in the methods of the present invention. For example, the base fluid may comprise water, acids, oils, or mixtures thereof. In certain embodiments of the present invention wherein the base fluid comprises water, the water used may be freshwater, salt water (e.g., water containing one or more salts dissolved therein), brine (e.g., saturated salt water), or seawater. Generally, the water may be from any source, provided that it does not contain an excess of compounds that may adversely affect other components in the treatment fluid. Examples of suitable acids include, but are not limited to, hydrochloric acid, acetic acid, formic acid, citric acid, or mixtures thereof. In certain embodiments, the base fluid may further comprise a gas (e.g., nitrogen, or carbon dioxide). Generally, the base fluid is present in the wellbore treatment composition in an amount in the range of from about 25% to about 99% by weight of the wellbore treatment composition.

In one embodiment, the base fluid is present in the wellbore treatment composition in the range of from about 70 to 99 weight percent based on the total weight of the wellbore treatment composition. In one embodiment, the base fluid is present in the wellbore treatment composition in the range of from about 70 to 80 weight percent based on the total weight of the wellbore treatment composition. In one class of this embodiment, the base fluid is present in the wellbore treatment composition in the range of from about 80 to 99.9 weight percent based on the total weight of the wellbore treatment composition. In one class of this embodiment, the base fluid is present in the wellbore treatment composition in the range of from about 80 to 99 weight percent based on the total weight of the wellbore treatment composition. In one class of this embodiment, the base fluid is present in the composition in the range of from about 80 to 90 weight percent based on the total weight of the composition. In one class of this embodiment, the base fluid is present in the composition in the range of from about 90 to 99 weight percent based on the total weight of the composition.

The wellbore treatment fluids can be in the form of slurries and be selected from the grouping consisting of a hydraulic fracturing fluid, a drilling fluid, a channelant formation agent, a completion fluid, a flowback control agent, a proppant transport fluid, a viscosifier extension agent, a plug flow agent, or a fluid carrier.

Hydrocarbons (e.g., oil, condensate, and gas) are typically produced from wells that are drilled into the formations containing them. Often, for a variety of reasons, such as inherently low permeability of the formation or damage to the formation caused by drilling, the flow of hydrocarbons into the well is undesirably low. In such scenarios, the well is often “stimulated.” One of the most common forms of stimulation is hydraulic fracturing, in which a fluid is injected into the formation at a pressure above the “fracture” pressure of the formation. A fracture is formed and grows into the formation, greatly increasing the surface area through which fluids may flow into the well. When the injection pressure is released, the fracture closes. Consequently, a particulate material, often called a “proppant,” is included in the fracturing fluid so that when the pressure is released, the fracture cannot close completely, but rather closes on the proppant. Therefore, the formed fractures are held apart by a bed of proppant through which the fluids may then flow to the well. The fracturing fluid normally must have a minimal viscosity that serves two purposes. First, the more viscous the fluid the more readily the fracture will be widened by injection of the fluid, and, second, a more viscous fluid will more readily transport proppant, hence the term “carrier” fluid. However, when the fluid is viscosified with a polymer or fiber, as is often the case, at least some of the polymer or fiber is left in the fracture after the treatment. This viscosifier left in the fracture can inhibit the flow of desirable fluids out of the formation, through the fracture, into the wellbore, and to the surface for recovery.

The first solid particulate may be present in the wellbore treatment composition in an amount sufficient to provide a desired amount of fluid loss control. In one embodiment, the first solid particulate is present in the wellbore treatment composition in the range of from about 0.1 wt % to about 20 wt %. In one embodiment, the first solid particulate is present in the wellbore treatment composition in the range of from about 0.1 wt % to about 10 wt %. In one embodiment, the first solid particulate is present in the wellbore treatment composition in the range of from about 0.1 wt % to about 5 wt %. In one embodiment, the first solid particulate is present in the wellbore treatment composition in the range of from about 0.1 wt % to about 2.5 wt %. In one embodiment, the first solid particulate is present in the wellbore treatment composition in the range of from about 0.1 wt % to about 1 wt %. In one embodiment, the first solid particulate is present in the wellbore treatment composition in the range of from about 0.1 wt % to about 0.5 wt %.

In one embodiment, the first degradable material comprises (I) a cellulosic polymer comprising a plurality of —CH₂COOR¹ substituents, wherein the degree of substitution of the —CH₂COOR¹ substituents is in the range of from about 0.4 to about 1.5; and a plurality of (C₁₋₆)alkyl-CO— substituents, wherein the degree of substitution of the (C₁₋₆)alkyl-CO— substituents is in the range of from 0 to about 2.5, wherein R¹ is hydrogen or (C₁₋₆)alkyl.

In one class of this embodiment, R¹ is a (C₁₋₆)alkyl.

In one subclass of this class, the degree of substitution of the —CH₂COOR¹ substituents is in the range of from about 0.4 to about 0.6. In one subclass of this class, the degree of substitution of the —CH₂COOR¹ substituents is in the range of from about 0.6 to about 0.8. In one subclass of this class, the degree of substitution of the —CH₂COOR¹ substituents is in the range of from about 0.8 to about 1.0. In one subclass of this class, the degree of substitution of the —CH₂COOR¹ substituents is in the range of from about 1.0 to about 1.2. In one subclass of this class, the degree of substitution of the —CH₂COOR¹ substituents is in the range of from about 1.2 to about 1.4. In one subclass of this class, the degree of substitution of the —CH₂COOR¹ substituents is in the range of from about 0.7 to about 1.2.

In one class of this embodiment, R¹ is hydrogen.

In one subclass of this class, the degree of substitution of the —CH₂COOR¹ substituents is in the range of from about 0.4 to about 0.6. In one subclass of this class, the degree of substitution of the —CH₂COOR¹ substituents is in the range of from about 0.6 to about 0.8. In one subclass of this class, the degree of substitution of the —CH₂COOR¹ substituents is in the range of from about 0.8 to about 1.0. In one subclass of this class, the degree of substitution of the —CH₂COOR¹ substituents is in the range of from about 1.0 to about 1.2. In one subclass of this class, the degree of substitution of the —CH₂COOR¹ substituents is in the range of from about 1.2 to about 1.4. In one subclass of this class, the degree of substitution of the —CH₂COOR¹ substituents is in the range of from about 0.7 to about 1.2.

In one embodiment, the first degradable material comprises (I) a cellulosic polymer comprising: (b) a plurality of —(C₂₋₃)alkyl-OR² substituents, wherein the degree of substitution of the —(C₂₋₃)alkyl-OR² substituents is in the range of from about 0.4 to about 2.9; and a plurality of (C₁₋₆)alkyl-CO— substituents, wherein the degree of substitution of the (C₁₋₆)alkyl-CO— substituents is in the range of from 0 to about 2.5; wherein R² is hydrogen, or (C₁₋₆)alkyl-CO—.

In one embodiment, the first degradable material comprises (I) a cellulosic polymer comprising (c) a plurality of COOH substituents, wherein the degree of substitution of the COOH substituents is in the range of from 0.1 to 0.5, and a plurality of (C₁₋₆)alkyl-CO— substituents, wherein the degree of substitution of the (C₁₋₆)alkyl-CO— substituents is in the range of from 0 to about 2.5.

In one class of this embodiment, the degree of substitution of the (C₁₋₆)alkyl-CO— substituents is in the range of from 0 to about 0.5. In one class of this embodiment, the degree of substitution of the (C₁₋₆)alkyl-CO— substituents is in the range of from 0.5 to about 1.0. In one class of this embodiment, the degree of substitution of the (C₁₋₆)alkyl-CO— substituents is in the range of from 1.0 to about 1.5. In one class of this embodiment, the degree of substitution of the (C₁₋₆)alkyl-CO— substituents is in the range of from 1.5 to about 2.0. In one class of this embodiment, the degree of substitution of the (C₁₋₆)alkyl-CO— substituents is in the range of from 2.0 to about 2.5.

In one embodiment, the first degradable material comprises: (I) a cellulosic polymer comprising (d) a plurality of

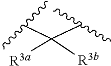

substituents which are acetals or ketals, wherein the degree of substitution of the

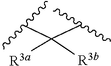

substituents is from about 0.2 to about 1, wherein each R^{3a} and R^{3b} are independently hydrogen, (C₁₋₆)alkyl, (C₃₋₆)cycloalkyl, or phenyl, and R^{3a} and R^{3b} are not both hydrogen.

In one class of this embodiment, the degree of substitution of the

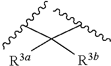

substituents is from about 0.2 to about 0.4. In one class of this embodiment, the degree of substitution of the

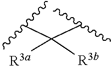

substituents is from about 0.4 to about 0.6. In one class of this embodiment, the degree of substitution of the

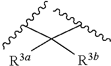

substituents is from about 0.6 to about 0.8. In one class of this embodiment, the degree of substitution of the

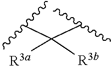

substituents is from about 0.28 to about 1.0.

In one embodiment, the first degradable material comprises: (II) a polyester polymer comprising 5 mole % to 30 mole % of isophthalic-S(O)₂—OH residues based on the total diacid component of the polyester polymer.

In one embodiment, the first degradable material comprises: (III) a polyvinyl alcohol comprising a plurality of R⁵—CO— substituents, wherein each R⁵ is hydrogen or a (C₁₋₆)alkyl.

In one class of this embodiment, each R⁵ is hydrogen.

In one class of this embodiment, each R⁵ is a (C₁₋₆)alkyl.

In one embodiment, the first degradable material comprises: (IV) guar gum ester, comprising a plurality of a (C₁₋₆)alkyl-CO— substituents, wherein the degree of substitution of the (C₁₋₆)alkyl-CO— is in the range of from 0.4 to 2.7.

In one class of this embodiment, the degree of substitution of the (C₁₋₆)alkyl-CO— is in the range of from 0.4 to 0.8. In one class of this embodiment, the degree of substitution of the (C₁₋₆)alkyl-CO— is in the range of from 0.8 to 1.2. In one class of this embodiment, the degree of substitution of the (C₁₋₆)alkyl-CO— is in the range of from 1.2 to 1.6. In one class of this embodiment, the degree of substitution of the (C₁₋₆)alkyl-CO— is in the range of from 1.6 to 2.0. In one class of this embodiment, the degree of substitution of the (C₁₋₆)alkyl-CO— is in the range of from 2.0 to 2.4. In one class of this embodiment, the degree of substitution of the (C₁₋₆)alkyl-CO— is in the range of from 2.4 to 2.7.

In one embodiment, the downhole diverter composition further comprises (3) a second solid particulate, comprising a second degradable material, wherein the second solid particulate has a second graded particle size in the range of from about 6 to about 8 U.S. Standard Mesh, wherein the second solid particulate exhibits a percent weight loss of not more than forty percent (40%) after 4 hours at 100° C. in deionized water, wherein the second degradable material is: (I) a cellulosic polymer comprising: a cellulosic polymer comprising (a) a plurality of —CH₂COOR⁶ substituents, wherein the degree of substitution of the —CH₂COOR⁶ substituents is in the range of from about 0.4 to about 1.5; and a plurality of (C₁₋₆)alkyl-CO— substituents, wherein the degree of substitution of the (C₁₋₆)alkyl-CO— substituents is in the range of from 0 to about 2.5, wherein R⁶ is hydrogen or (C₁₋₆)alkyl; (b) a plurality of (C₂₋₃)alkyl-OR⁷ substituents, wherein the degree of substitution of the (C₂₋₃)alkyl-OR⁷ substituents is in the range of from about 0.4 to about 2.9; and a plurality of (C₁₋₆)alkyl-CO— substituents, wherein the degree of substitution of the (C₁₋₆)alkyl-CO— substituents is in the range of from 0 to about 2.5; wherein R⁷ is hydrogen, or (C₁₋₆)alkyl-CO—; (c) a plurality of COOH substituents, wherein the degree of substitution of the COOH substituents is in the range of from 0.1 to 0.5, and a plurality of (C₁₋₆)alkyl-CO— substituents, wherein the degree of substitution of the (C₁₋₆)alkyl-CO— substituents is in the range of from 0 to about 2.5; (d) a plurality of

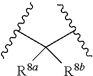

substituents which are acetals or ketals, wherein the degree of substitution of the

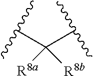

substituents is from about 0.2 to about 1, wherein each R^{8a} and R^{8b} are independently hydrogen, (C₁₋₆)alkyl, (C₃₋₆)cycloalkyl, or phenyl; (II) a polyester polymer comprising 5 mole % to 30 mole % of isophthalic-S(O)₂—OH residues based on the total diacid component of the polyester polymer; (III) a polyvinyl alcohol comprising a plurality of R¹⁰—CO— substituents, wherein each R¹⁰ is independently hydrogen or (C₁₋₆)alkyl; or (IV) guar gum ester, comprising a plurality of (C₁₋₆)alkyl-CO— substituents, wherein the degree of substitution of the (C₁₋₆)alkyl-CO— is in the range of from 0.4 to 2.7.

In one class of this embodiment, the second degradable material comprises is (I) a cellulosic polymer comprising (a) a plurality of —CH₂COOR⁶ substituents, wherein the degree of substitution of the —CH₂COOR⁶ substituents is in the range of from about 0.4 to about 1.5; and a plurality of (C₁₋₆)alkyl-CO— substituents, wherein the degree of substitution of the (C₁₋₆)alkyl-CO— substituents is in the range of from 0 to about 2.5, wherein R⁶ is hydrogen or (C₁₋₆)alkyl.

In one subclass of this class, R⁶ is a (C₁₋₆)alkyl.

In one sub-subclass of this subclass, the degree of substitution of the —CH₂COOR⁶ substituents is in the range of from about 0.4 to about 0.6. In one sub-subclass of this subclass, the degree of substitution of the —CH₂COOR⁶ substituents is in the range of from about 0.6 to about 0.8. In one sub-subclass of this subclass, the degree of substitution of the —CH₂COOR⁶ substituents is in the range of from about 0.8 to about 1.0. In one sub-subclass of this subclass, the degree of substitution of the —CH₂COOR⁶ substituents is in the range of from about 1.0 to about 1.2. In one sub-subclass of this subclass, the degree of substitution of the —CH₂COOR⁶ substituents is in the range of from about 1.2 to about 1.4. In one sub-subclass of this subclass, the degree of substitution of the —CH₂COOR⁶ substituents is in the range of from about 0.7 to about 1.2.

In one subclass of this class, R⁶ is hydrogen.

In one sub-subclass of this subclass, the degree of substitution of the —CH₂COOR⁶ substituents is in the range of from about 0.4 to about 0.6. In one sub-subclass of this subclass, the degree of substitution of the —CH₂COOR⁶ substituents is in the range of from about 0.6 to about 0.8. In one sub-subclass of this subclass, the degree of substitution of the —CH₂COOR⁶ substituents is in the range of from about 0.8 to about 1.0. In one sub-subclass of this subclass, the degree of substitution of the —CH₂COOR⁶ substituents is in the range of from about 1.0 to about 1.2. In one sub-subclass of this subclass, the degree of substitution of the —CH₂COOR⁶ substituents is in the range of from about 1.2 to about 1.4. In one sub-subclass of this subclass, the degree of substitution of the —CH₂COOR⁶ substituents is in the range of from about 0.7 to about 1.2.

In one class of this embodiment, the first degradable material comprises (I) a cellulosic polymer comprising: (b) a plurality of (C₂₋₃)alkyl-OR⁷ substituents, wherein the degree of substitution of the (C₂₋₃)alkyl-OR⁷ substituents is in the range of from about 0.4 to about 2.9; and a plurality of (C₁₋₆)alkyl-CO— substituents, wherein the degree of substitution of the (C₁₋₆)alkyl-CO— substituents is in the range of from 0 to about 2.5; wherein R⁷ is hydrogen, or (C₁₋₆)alkyl-CO—.

In one class of this embodiment, the first degradable material comprises (I) a cellulosic polymer comprising (c) a plurality of COOH substituents, wherein the degree of substitution of the COOH substituents is in the range of from 0.1 to 0.5, and a plurality of (C₁₋₆)alkyl-CO— substituents, wherein the degree of substitution of the (C₁₋₆)alkyl-CO— substituents is in the range of from 0 to about 2.5.

In one subclass of this class, the degree of substitution of the (C₁₋₆)alkyl-CO— substituents is in the range of from 0 to about 0.5. In one subclass of this class, the degree of substitution of the (C₁₋₆)alkyl-CO— substituents is in the range of from 0.5 to about 1.0. In one subclass of this class, the degree of substitution of the (C₁₋₆)alkyl-CO— substituents is in the range of from 1.0 to about 1.5. In one class of this embodiment, the degree of substitution of the (C₁₋₆)alkyl-CO— substituents is in the range of from 1.5 to about 2.0. In one subclass of this class, the degree of substitution of the (C₁₋₆)alkyl-CO— substituents is in the range of from 2.0 to about 2.5.

In one class of this embodiment, the first degradable material comprises: (I) a cellulosic polymer comprising (d) a plurality of

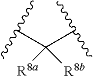

substituents which are acetals or ketals, wherein the degree of substitution of the

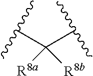

substituents is from about 0.2 to about 1, wherein each R^{8a} and R^{8b} are independently hydrogen, (C₁₋₆)alkyl, (C₃₋₆)cycloalkyl, or phenyl.

In one subclass of this class, the degree of substitution of the

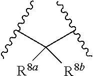

substituents is from about 0.2 to about 0.4. In one subclass of this class, the degree of substitution of the

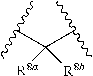

substituents is from about 0.4 to about 0.6. In one subclass of this class, the degree of substitution of the

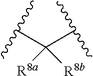

substituents is from about 0.6 to about 0.8. In one subclass of this class, the degree of substitution of the

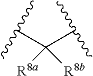

substituents is from about 0.28 to about 1.0.

In one class of this embodiment, the first degradable material comprises: (II) a polyester polymer comprising 5 mole % to 30 mole % of isophthalic-S(O)₂—OH residues based on the total diacid component of the polyester polymer, wherein each R⁹ is independently hydrogen or (C₁₋₆)alkyl.

In one class of this embodiment, the first degradable material comprises: ; (III) a polyvinyl alcohol comprising a plurality of R¹⁰—CO— substituents, wherein R¹⁰ is hydrogen or (C₁₋₆)alkyl.

In one subclass of this class, each R¹⁰ is hydrogen.

In one subclass of this class, each R¹⁰ is a (C₁₋₆)alkyl.

In one class of this embodiment, the first degradable material comprises: (IV) guar gum ester, comprising a plurality of (C₁₋₆)alkyl-CO— substituents, wherein the degree of substitution of the (C₁₋₆)alkyl-CO— is in the range of from 0.4 to 2.7.

In one subclass of this class, the degree of substitution of the (C₁₋₆)alkyl-CO— is in the range of from 0.4 to 0.8. In one class of this embodiment, the degree of substitution of the (C₁₋₆)alkyl-CO— is in the range of from 0.8 to 1.2. In one class of this embodiment, the degree of substitution of the (C₁₋₆)alkyl-CO— is in the range of from 1.2 to 1.6. In one class of this embodiment, the degree of substitution of the (C₁₋₆)alkyl-CO— is in the range of from 1.6 to 2.0. In one class of this embodiment, the degree of substitution of the (C₁₋₆)alkyl-CO— is in the range of from 2.0 to 2.4. In one class of this embodiment, the degree of substitution of the (C₁₋₆)alkyl-CO— is in the range of from 2.4 to 2.7.

When the polymer is a cellulosic polymer comprising a plurality of —CH₂COOR¹ substituents, wherein R¹ is hydrogen (or —CH₂COOR⁶ substituents, wherein R⁶ is hydrogen), the cellulosic polymer is formed from the treatment of a sodium carboxymethyl cellulose with an acid. The acid typically will have a pKa of less than 4. Nonlimiting examples of acids include sulfuric acid, hydrochloric acid, hydrobromic acid, and the like. The acid can be used as an aqueous solution.

### EXAMPLES

The following examples are given to illustrate the compositions and should not be construed as limiting in scope.

### Abbreviations

Acetamido-TEMPO is 4-Acetamido-2,2,6,6-tetramethylpiperidine 1-oxyl; AcOH is acetic acid; Ac₂O is acetic anhydride; ° C. is degree Celsius; DS is degree of substitution; DS_{Ac} is the degree of substitution for acetyl substituents; DS_{OH} is the degree of substitution for hydroxyl (hydroxyls not substituted); DS_{CH2COOH} is the degree of substitution for the carboxymethyl substituent; DS_{COOH} is degree of substitution for the carboxyl substituent; Ex is example(s); g is gram; h is hour; L is liter; MeOH is methanol; min is minute(s); mL is milliliter; Mₙ is number average molecular weight; M_{w} is mass average molecular weight; NMP is N-methyl-2-pyrrolidone; NMR is nuclear magnetic resonance; PDI is polydispersity index; SM is starting material; Temp. is temperature; wt % is weight percent.

### Example 1

### Preparation of Hydrogen Carboxymethyl Cellulose (DS_{CH2COOH}=1.2)

Sodium carboxymethyl cellulose (DS_{CH2COONa}=1.2, Sigma Aldrich Catalog number 419281) was stirred in a 10% sulfuric acid in MeOH solution (4 h). The solid was then filtered, washed with MeOH (2×), acetone (1×), air dried (18 h) and oven dried in vacuo (24 h) to give the titled compound.

### Example 2

### Hydrogen Carboxymethyl Cellulose (DS_{CH2COOH}=0.7, Sigma Aldrich catalog number 419311)

Ex 2 was prepared by adapting the procedure of Ex 1 starting from sodium carboxymethyl cellulose (DS_{CH2COONa}=0.7).

Ex 3-5 are carboxylated cellulose esters prepared by adapting the procedures in U.S. Pat. No. 7,879,994. The general procedure is as follows: Cellulose ester (150 g) and AcOH (1.55 L) were mixed at 50° C. in a round bottom flask until a homogeneous reaction mixture was obtained. Then water (232.5 mL) followed by acetamido-TEMPO (2.8 g) and NaBr (1.4 g) was added to the reaction mixture. Following, 32% peracetic acid (124.6 mL) was added dropwise (1 drop/4 seconds) to the reaction mixture. The reaction mixture was stirred at 50° C. (overnight). The reaction mixture was cooled to room temperature, poured into water, and the solid was filtered and washed with water (overnight). The solids were dried in vacuo in an oven (60° C.).

Table 1 provides the Mₙ, M_{w}, PDI, and degree of substitution (DS_{Ac}, DS_{OH}, and DS_{COOH}) for Ex 3-5. The Mₙ and M_{w} were determined by GPC using NMP as the solvent; The DS_{Ac}, DS_{OH}, and DS_{COOH} was determined by proton NMR.

TABLE 1

| Ex | SM | Mₙ | M_{w} | PDI | DS_{Ac} | DS_{OH} | DS_{COOH} |
|---|---|---|---|---|---|---|---|
| 3 | Eastman | 21617 | 85108 | 3.937 | 1.57 | 1.01 | 0.42 |
| | CA 320S | | | | | | |
| 4 | Eastman | 26629 | 111293 | 4.179 | 1.42 | 0.27 | 0.31 |
| | LA 150 | | | | | | |
| 5 | Eastman | 44689 | 88336 | 1.977 | 1.40 | 0.34 | 0.26 |
| | CA 398-3 | | | | | | |

### Example 6

### Hydroxyethyl Cellulose Acetate

Hydroxyethyl cellulose (HEC, Sigma Adrich Catalog No. 434981) (143.19 g) and AcOH (300 g) were heated to 55° C. The reaction mixture was then cooled to 32° C., and a solution of Ac₂O (249.73 g) and sulfuric acid (0.49 g) cooled to 5° C. was added to the reaction mixture. The reaction mixture was cool to 0° C. for ˜120 min, after which a solution of AcOH (54.81 g) and sulfuric acid (5.60 g) was added. The reaction mixture was heated to 61° C., at which time a solution of magnesium acetate tetrahydrate (6.13 g), AcOH (384 g) and water (325 g) was added. After 500 min, another solution of magnesium acetate tetrahydrate (7.19 g), AcOH (63 g) and water (48 g) was added. The solid material was filtered, rinsed thoroughly with water, and then dried in vacuo (60° C.). NMR provides the evidence of HEC acetate formation. 600 MHz NMR, Acetyl peaks at 1.95 ppm, and 1.85 ppm. Calculated DS_{Ac} is 1.96.

### Degradation Studies

All the degradation studies were conducted with grinded particle with mesh size of 500 micron. Particle size analysis were done with particle size analyzer and volume weighted diameter was calculated for each of the particle.

A diverting material should dissolve slowly so that it persists during the simulation treatment. After the treatment, the diverting material should dissolve or disperse in a reasonable amount of time to prevent formation damage and production or injection delays after treatment (Gomaa, A. M., et al., Experimental Investigation of Particulate Diverter Used to Enhance Fracture Complexity. Society of Petroleum Engineers). Therefore, dissolution tests were performed in closed and static conditions (no agitation) in a high pressure chamber. The initial solid diverter concentration is 0.1 gm Ex 1 or 2 in 10 mL deionized water. Dissolution tests were conducted using medium- or fine-mesh-size solid diverter particles. Dissolution experiments were carried out at four different temperatures (50° C., 70° C., 90° C., and 100° C.) in deionized water medium or 15% aqueous NaCl.

### Degradation Study 1

Table 2 provides the dissolution rate for Ex 1 and 2 as tested in deionized water at 50° C.

TABLE 1

| | Ex 1 | Ex 2 |
|---|---|---|
| Hours | % wt. loss | % wt loss |
| 24 | 15 | 10 |
| 72 | 29 | 15 |
| 120 | 44 | 30 |
| 168 | 60 | 50 |
| 240 | 81 | 70 |

### Degradation Study 2

Table 3 provides the dissolution rate for Ex 1 and 2 as tested in deionized water at 70° C.

TABLE 3

| | Ex 1 | Ex 2 |
|---|---|---|
| Hours | % wt. loss | % wt. loss |
| 24 | 47 | 36 |
| 72 | 64 | 42 |
| 120 | 73 | 56 |
| 168 | 100 | 74 |
| 240 | — | 100 |

### Degradation Study 3

Table 4 provides the dissolution rate for Ex 1 and 2 as tested in deionized water at 90° C.

TABLE 4

| | Ex 1 | Ex 2 |
|---|---|---|
| Hours | % wt. loss | % wt. loss |
| 24 | 70 | 58 |
| 72 | 100 | 100 |

### Degradation Study 4

Table 5 provides the dissolution rate for Ex 1 and 2 as tested in deionized water at 100° C.

TABLE 5

| | Ex 1 | Ex 2 |
|---|---|---|
| Hours | % wt. loss | % wt. loss |
| 4 | 36 | 26 |
| 8 | 42 | 44 |
| 16 | 65 | 66 |
| 24 | 71 | 70 |
| 48 | 100 | 100 |

### Degradation Study 5

Table 6 provides the dissolution rate for Ex 1 and 2 as tested in 15% NaCl in water at 70° C.

TABLE 6

| | Ex 1 | Ex 2 |
|---|---|---|
| Hours | % wt. loss | % wt. loss |
| 24 | 8 | 7 |
| 72 | 41 | 25 |
| 120 | 55 | 40 |
| 168 | 66 | 52 |

In general, the data shows that a lower degree of substitution of the hydrogen carboxymethyl group, the lower the rate of dissolution or dispersion. The rate of dissolution or dispersion for sodium salts of carboxymethyl cellulose derivative is in the order of minutes (10-30 min) based on the temperature. Therefore, the rate of degradation of the hydrogen carboxymethyl cellulose can be tuned by adjusting the degree of substitution of the hydrogen carboxymethyl substituents.

Tables 7-10 provide dissolution studies for Ex 3-5 at various temperatures in deionized water.

### Dissolution Study 6

Table 7 provides the dissolution results for Ex 3 at 50° C. in deionized water.

TABLE 7

| | Ex 3 |
|---|---|
| Hours | % wt. loss |
| 24 | 10 |
| 48 | 35 |
| 72 | 60 |
| 96 | 100 |

### Dissolution Study 7

Table 8 provides the dissolution results for Ex 3-5 at 70° C. in deionized water.

TABLE 8

| | Ex 3 | Ex 4 | |
|---|---|---|---|
| Hours | % wt. loss | % wt. loss | Ex 5 |
| 6 | 12 | — | — |
| 10 | 20 | — | — |
| 16 | 45 | — | — |
| 36 | 100 | — | — |
| 48 | — | 6 | 4 |
| 96 | — | 25 | 20 |
| 192 | — | 70 | 75 |
| 240 | — | 100 | 100 |

### Dissolution Study 6

Table 7 provides the dissolution results for Ex 4 at 100° C. in deionized water.

TABLE 9

| | Ex 4 |
|---|---|
| Hours | % wt. loss |
| 8 | 4 |
| 20 | 8 |
| 72 | 45 |
| 120 | 100 |

Table 10 provides a summary of complete dissolution times for Ex 3-5 at various temperatures.

TABLE 10

| Temp. (° C.) | Ex 3 | | Ex 4 | Ex 5 |
|---|---|---|---|---|
| 40 | 14 | days | 33-35 days | 40-42 days |
| 50 | 4 | days | 22-23 days | 23-25 days |
| 70 | 36 | hours | 9-10 days | 14-15 days |
| 100 | 12-14 | hours | 5 days | 7 days |

1. A wellbore treatment composition comprising:
(1) a first solid particulate, comprising a first degradable material; and
(2) a base fluid,
wherein the first solid particulate has a first graded particle size in the range of from about 60 to about 100 U.S. Standard Mesh,
wherein the first solid particulate exhibits a percent weight loss of not more than forty percent (40%) after 4 hours at a temperature in the range of from 50° C. to 100° C. in deionized water,
wherein the first degradable material comprises is:
(I) a cellulosic polymer comprising
(a) a plurality of —CH₂COOR¹ substituents, wherein the degree of substitution of the —CH₂COOR¹ substituents is in the range of from about 0.4 to about 1.5; and a plurality of (C₁₋₆)alkyl-CO— substituents, wherein the degree of substitution of the (C₁₋₆)alkyl-CO— substituents is in the range of from 0 to about 2.5, wherein R¹ is hydrogen or (C₁₋₆)alkyl;
(b) a plurality of —(C₂₋₃)alkyl-OR² substituents, wherein the degree of substitution of the —(C₂₋₃)alkyl-OR² substituents is in the range of from about 0.4 to about 2.9; and a plurality of (C₁₋₆)alkyl-CO— substituents, wherein the degree of substitution of the (C₁₋₆)alkyl-CO— substituents is in the range of from 0 to about 2.5; wherein R² is hydrogen, or (C₁₋₆)alkyl-CO—;
(c) a plurality of COOH substituents, wherein the degree of substitution of the COOH substituents is in the range of from 0.1 to 0.5, and a plurality of (C₁₋₆)alkyl-CO— substituents, wherein the degree of substitution of the (C₁₋₆)alkyl-CO— substituents is in the range of from 0 to about 2.5; or
(d) a plurality of 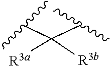
substituents which are acetals or ketals, wherein the degree of substitution of the 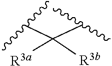
substituents is from about 0.2 to about 1, wherein each R^{3a} and R^{3b} are independently hydrogen, (C₁₋₆)alkyl, (C₃₋₆)cycloalkyl, or phenyl, and R^{3a} and R^{3b} are not both hydrogen;
(II) a polyester polymer comprising 5 mole % to 30 mole % of isophthalic-S(O)₂—OH residues based on the total diacid component of the polyester polymer;
(III) a polyvinyl alcohol comprising a plurality of R⁵—CO— substituents, wherein each R⁵ is independently hydrogen or (C₁₋₆)alkyl; or
(IV) a guar gum ester, comprising a plurality of (C₁₋₆)alkyl-CO— substituents, wherein the degree of substitution of the (C₁₋₆)alkyl-CO— is in the range of from 0.4 to 2.7.

2. The composition of claim 1, wherein the first solid particulate exhibits a percent weight loss of at least sixty-five percent (65%) after 48 hours at a temperature in the range of from 50° C. to 100° C. in deionized water.

3. The composition of claim 1, wherein the first solid particulate exhibits a percent weight loss of at least sixty-five percent (65%) after 192 hours at a temperature in the range of from 50° C. to 100° C. in deionized water.

4. The composition of claim 2, wherein the base fluid is present in the composition in the range of from about 80 to 99 weight percent based on the total weight of the composition.

5. The composition of claim 1, wherein the composition further comprises a proppant.

6. The composition of claim 1, further comprising: (3) a second solid particulate, comprising a second degradable material,
wherein the second solid particulate has a second graded particle size in the range of from about 6 to about 8 U.S. Standard Mesh,
wherein the first solid particulate exhibits a percent weight loss of not more than forty percent (40%) after 4 hours at a temperature in the range of from 50° C. to 100° C. in deionized water,
wherein the second degradable material comprises is:
(I) a cellulosic polymer comprising
(a) a plurality of —CH₂COOR⁶ substituents, wherein the degree of substitution of the —CH₂COOR⁶ substituents is in the range of from about 0.4 to about 1.5; and a plurality of (C₁₋₆)alkyl-CO— substituents, wherein the degree of substitution of the (C₁₋₆)alkyl-CO— substituents is in the range of from 0 to about 2.5, wherein R⁶ is hydrogen or (C₁₋₆)alkyl;
(b) a plurality of (C₂₋₃)alkyl-OR⁷ substituents, wherein the degree of substitution of the (C₂₋₃)alkyl-OR⁷ substituents is in the range of from about 0.4 to about 2.9; and a plurality of (C₁₋₆)alkyl-CO— substituents, wherein the degree of substitution of the (C₁₋₆)alkyl-CO— substituents is in the range of from 0 to about 2.5; wherein R⁷ is hydrogen, or (C₁₋₆)alkyl-CO—;
(c) a plurality of COOH substituents, wherein the degree of substitution of the COOH substituents is in the range of from 0.1 to 0.5, and a plurality of (C₁₋₆)alkyl-CO— substituents, wherein the degree of substitution of the (C₁₋₆)alkyl-CO— substituents is in the range of from 0 to about 2.5;
(d) a plurality of 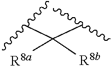
substituents which are acetals or ketals, wherein the degree of substitution of the 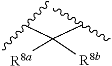
substituents is from about 0.2 to about 1, wherein each R^{8a} and R^{8b} are independently hydrogen, (C₁₋₆)alkyl, (C₃₋₆)cycloalkyl, or phenyl;
(II) a polyester polymer comprising 5 mole % to 30 mole % of isophthalic-S(O)₂—OH residues based on the total diacid component of the polyester polymer;
(III) a polyvinyl alcohol comprising a plurality of R¹⁰—CO— substituents, wherein each R¹⁰ is independently hydrogen or (C₁₋₆)alkyl; or
(IV) guar gum ester, comprising a plurality of (C₁₋₆)alkyl-CO— substituents, wherein the degree of substitution of the (C₁₋₆)alkyl-CO— is in the range of from 0.4 to 2.7.

7. A method of well treatment, comprising:
(1) injecting the composition of claim 1 into a downhole well formation;
(2) allowing the first solid particulate in the composition to form a plug in one or more than one of a perforation, a fraction, and a wellbore in the downhole well formation;
(3) performing at least one downhole operation; and
(4) allowing the first particulate material to at least partially degrade.

8. The method of claim 7, wherein the operation is a fracturing operation.

9. The composition of claim 3, wherein the base fluid is present in the composition in the range of from about 80 to 99 weight percent based on the total weight of the composition.
